(19) United States
(12) Patent Application Publication
(10) Pub. No.: US 2020/0052548 A1
(43) Pub. Date: Feb. 13, 2020

(54) COOLING OF AN ELECTRIC MACHINE

(71) Applicant: SIEMENS AKTIENGESELLSCHAFT, 80333 München (DE)

(72) Inventors: Christoph Rogginger, Wittibreut (DE); Sebastian Weiss, Oberasbach (DE); Patric Willems, Postbauer-Heng (DE); Günther Winkler, Haibach (AT)

(73) Assignee: SIEMENS AKTIENGESELLSCHAFT, 80333 München (DE)

(21) Appl. No.: 16/491,438

(22) PCT Filed: Feb. 15, 2018
(86) PCT No.: PCT/EP2018/053788

§ 371 Date: Sep. 5, 2019

(30) Foreign Application Priority Data
Mar. 9, 2017 (EP) 17160141.2

(51) Int. Cl. H02K 5/24; H02K 9/06; H02K 5/20

(52) U.S. Cl. CPC H02K 5/24; H02K 5/20; H02K 9/06

(57) ABSTRACT

An electric machine includes a housing, a stator, a rotor which is rotatably mounted in a receiving area of the stator, a cooling device for discharging heat out of the housing, a heat exchanger which can be supplied with cooling air and which is arranged on the housing and is coupled to the cooling device, a cooling air channel, and a fan for introducing cooling air into the cooling air channel. The fan has a fan wheel rotatably mounted in a fan housing between two opposing air inlet openings of the fan housing. At least some regions of one of the two air inlet openings have a nozzle-type configuration. An air outlet opening is arranged in a radial direction of the fan wheel.

The invention relates to a machine having a housing, having a stationary part which is arranged non-rotatably in the housing, having a runner which is rotatably mounted in a receiving space of the stationary part, having a cooling device for discharging heat from the housing, having a heat exchanger which is able to be acted on by cooling air and which is arranged on the housing and is coupled to the cooling device, having a cooling-air duct for the supply and/or discharge of the cooling air, and having a fan for introducing the cooling air into the cooling-air duct, wherein the fan has a fan wheel which is mounted in a fan housing so as to be drivable in rotation, wherein the fan housing has two opposing air inlet openings, between which the fan wheel is arranged, and at least one air outlet opening, which is arranged in a radial direction of the fan wheel.

Generic electric machines are known extensively in principle in the prior art, and so there is no need for separate documentary evidence of this. In an electric machine, in particular a rotating electric machine, the stationary part is generally provided as a stator, which normally provides a substantially circular passage opening as a receiving space for receiving the runner, which is designed as a rotor. The runner is arranged in a rotatably mounted manner in the passage opening, wherein an air gap is formed between the runner and the stationary part.

An electric machine is an apparatus which converts electrical energy into mechanical energy, in particular energy of movement, during a motor operation, and/or mechanical energy into electrical energy during a generator operation. The movement is generally a rotational movement which is performed by the runner. By contrast to the runner, the stationary part is generally arranged non-rotatably, that is to say the rotational movement is a rotational movement of the runner with respect to the stationary part.

The stationary part and the runner are linked by means of a magnetic flux, as a result of which the force effect, specifically the torque, which drives the runner in rotation with respect to the stationary part is generated during motor operation and mechanical energy supplied to the runner in the form of rotation is converted into electrical energy during generator operation. For this purpose, the stationary part and the runner each have a winding through which an electrical current flows. In the stationary part or in the runner, the winding may also be formed or supplemented by a permanent magnet.

Rotating electric machines of the generic type are for example induction machines, which are connected to a multi-phase, in particular three-phase, electrical alternating-current voltage network, such as for example asynchronous machines, synchronous machines, synchronous machines with a damper cage or the like, or else direct-current machines such as shunt-wound or series-wound machines or the like.

Rotating electric machines generally have a housing which encloses the constituent parts of the rotating electric machine, or at least the stationary part and the runner. The electric machine generally also has a cooling device for discharging the heat from the housing by means of a cooling fluid. The cooling device may be arranged integrated into the housing. Furthermore, it may however also be arranged integrated at least partially into the stationary part and/or the runner.

Electric machines which are intended to be designed in a separated manner with respect to an external atmosphere, for example in that they are hermetically sealed off with respect thereto, often have a cooling device which, on the machine side, provides a closed cooling circuit for the cooling fluid. The cooling fluid may be liquid or else gaseous, in particular air. The cooling device is preferably connected to a heat exchanger through which the cooling fluid flows. For this purpose, the cooling device is fluidically coupled to the heat exchanger.

The heat exchanger preferably has a separate fluid duct for guiding cooling air, by means of which the cooling fluid can be contacted for the purpose of the heat exchange. The cooling fluid and the cooling air are separated in terms of substance contact in the heat exchanger.

In order for the cooling air to be able to flow through the heat exchanger, provision is made of the fan, which serves for introducing the cooling air into the cooling-air duct. The fan has a separate fan housing, in which a fan wheel of the fan is mounted in a rotatable and drivable manner. The fan housing furthermore has two opposing air inlet openings, between which the fan wheel is arranged, and at least one air outlet opening, which is arranged in a radial direction of the fan wheel. The fan wheel is generally arranged such that an axis of rotation of the fan wheel is oriented transversely with respect to a plane which is formed by the two opposing air inlet openings.

Even though this prior art has proven to be successful in principle, disadvantages are nevertheless evident. During operation of the electric machine as intended, noises arise owing to the operation of the fan, which can be highly disruptive according to the operating state of the electric machine.

The invention is based on the object of bringing about an improvement with regard to the noise generation of the electric machine.

As a solution, the invention proposes an electric machine according to the independent claim 1.

Advantageous refinements will emerge from features of the dependent claims.

For a generic electric machine, the invention proposes in particular that at least one of the two air inlet openings be formed at least regionally in the manner of a nozzle.

The invention is based on the realization that, through the configuration of the air inlet opening in the manner of a nozzle, the air flow into the fan can be improved such that a more favorable air flow can be achieved overall and consequently noise generation can be reduced too. Here, the invention is furthermore based on the concept that a measure for noise reduction is particularly favorable precisely at the air inlet opening, especially as the fan wheel is also arranged there, which for its part likewise influences the air flow. As a result of the configuration of the air inlet opening in the manner of a nozzle, it is possible to achieve a more favorable incident flow behavior of the cooling air with respect to the fan wheel, with the result that noise reduction can be achieved overall.

With the invention, it can thus also be achieved that, in electric machines, provision can be made for a high degree of utilization with respect to the cooling power, which generally requires highly efficient cooling. In large electric machines, this is achieved by means of the heat exchanger. Here, use is chiefly made of two variants, specifically re-cooling by means of an air-water heat coupler and re-cooling by means of an air-air heat exchanger. Even though the application of an air-air heat exchanger is used as a basis below, the functional principle of the invention is fundamentally also correspondingly applicable to an air-water heat exchanger.

In the case of an air-air heat exchanger, interior air, serving as cooling fluid, inside the housing of the electric machine is re-cooled using for example a tube-type heat exchanger. For this purpose, it is necessary for cooling air to be guided through cooling tubes of the heat exchanger in order to be able to discharge the heat from the heat exchanger. Ambient air is normally used as cooling air. In principle, however, it is also possible for use to be made of another suitable fluid cooling medium for this purpose. A substance separation between the cooling fluid and the cooling air is ensured by the cooling tubes of the heat exchanger. The machine-internal air stream thus corresponds to the cooling fluid of the cooling device, while the ambient air corresponds to the cooling air.

In order to make possible the conveyance of the ambient air to the heat exchanger, a technical air-conveying device is required. In the present case, this is provided by an air duct with a fan. During operation of the electric machine as intended, said air-conveying device constitutes a not inconsiderable source of noise emission. It is normally the case that the fan is driven via the runner of the electric machine, for example in that the fan wheel is fastened to a runner shaft and, during operation as intended, rotates together with the latter. The invention now makes it possible for the noise emissions of the fan to be significantly reduced.

For electric machines which are predominantly operated in an upper rotational speed range with only one direction of rotation, a so-called self-ventilated air-conveying device turns out to be advantageous. Since no separate electrical drive unit for the fan, in particular for the fan wheel thereof, is required in this configuration, the reliability of said electric machine is also increased because an additional technical subassembly in the form of the drive unit can be saved. With the self-ventilated air-conveying device, a non-drive side of the runner or of a runner shaft of the runner is preferably used, the non-drive-side shaft end being led out of the electric machine or the housing of the electric machine and being able to be used for the driving of the fan wheel. The fan wheel itself may be designed in the manner of a radial or else axial fan wheel and have corresponding air blades.

For the self-ventilated air-conveying device, owing to the maintenance effort and the improvement in the reliability of the electric machine, a transmission gearing, which would be able to establish a coupling of the fan wheel to the shaft end of the runner shaft, is generally unsuitable. For this reason, in the case of a self-ventilated air-conveying device, the fan wheel is generally designed for an operating rotational speed of the electric machine during operation as intended, because said fan wheel is preferably driven directly by the runner shaft.

Although an axial fan wheel is suitable for the conveyance of a relatively large volume flow of cooling air, it turns out to be a disadvantage here that, in order to be able to overcome a high counterpressure, the fan wheel must have a large diameter and/or has to be operated at a high rotational speed. The disadvantage that the noise generated by an axial fan wheel increases with its size in terms of its diameter and with its operating rotational speed is in particular evident here. It should also be taken into consideration that the operation of an axial fan wheel transmits an axial force with respect to the runner shaft on the latter. In particular in the case of runner shafts which are slidingly mounted in a floating manner, permissible limit values can be quickly exceeded here.

It furthermore turns out to be a disadvantage that, in modularly constructed electric machines having a cooling device which have an interior recirculation air cooling circuit, it is necessary due to design for the air stream of the cooling air to be diverted through approximately 90° immediately after exiting the axial fan.

Although this is not necessary with radial fans, strength and/or stability limits are quickly reached by a radial fan wheel with a correspondingly large diameter at a high operating rotational speed. Furthermore, it should be noted that single-channel radial fan wheels are also, like axial fan wheels, not free of an axial transmission of force to the runner shaft. Nevertheless, contrasting with this is the advantage that the radial fan allows a significantly higher generation of pressure in comparison with a correspondingly powerful axial fan. Here, however, a disadvantage turns out to be the volume flow limitation due to the size of an intake opening or air inlet opening of the radial fan, which for its part depends on a diameter of the fan wheel and thus acts in a rotational speed-limiting manner. For high volume flows, a radial fan having a large diameter, that is to say large mechanical dimensions, is thus absolutely necessary, without the need for the necessary large pressure which the radial fan is capable of generating. However, there is then the problem that the radial fan can be operated in an unfavorable operating state, which can result in unfavorable efficiency and—because of the large diameter—correspondingly high noise generation. For this reason, the invention provides that the fan has two opposing air inlet openings. This allows the above-described problems with regard to the radial fan to be avoided, or at least reduced. Consequently, provision is made of a two-channel fan, that is to say a fan whose fan housing has two opposing air inlet openings.

The invention is based on the use of a two-channel fan, preferably as a shaft fan. It may in particular be provided that one of the two air inlet openings has an air intake path in a space between an air guidance box and a non-drive-side bearing bracket of the electric machine.

If the fan wheel is of substantially symmetrical construction with respect to the intake of air, it can furthermore be achieved that substantially no axial forces are exerted on a drive unit for the fan wheel, for example the runner shaft. It is also possible to keep the diameter of the fan wheel small in the case of electric machines which are designed for high rotational speeds, even with large volume flows for the cooling air. This allows better efficiencies of such fans to be achieved, with noise emissions being able to be reduced at the same time.

It may also be provided that the region formed in the manner of a nozzle is adjoined in the flow direction by a region formed in the manner of a diffuser. This makes it possible to be able to achieve a further improvement with regard to the flow of the cooling air. In particular, a crossover of the flow of the cooling air from the air inlet opening to the fan wheel can be improved. In this way, it is possible both for the efficiency to be improved and for the noise generation to be further reduced.

It turns out to be particularly advantageous if a sound insulation wall is formed upstream of the at least one of the two air inlet openings in the flow direction. With the sound insulation wall, a further reduction of the sound emissions can be achieved. The sound insulation wall makes it possible to reduce or to avoid direct emissions of sound through the air inlet opening. Noises escaping through the air inlet opening can thus be damped more effectively.

The sound insulation wall may be a separate component, which is arranged in the region of the air inlet opening with a sufficient spacing such that the air flow of the cooling air is substantially unhindered. The sound insulation wall may in particular be at least a part of the fan housing or else of the housing of the electric machine. The sound insulation wall may be formed from metal, ceramic, plastic, a composite material and/or the like. Furthermore, it is possible that the sound insulation wall has, at least on the air inlet opening side, a surface structure which allows noises to be reduced. With regard to its dimensions, the surface structure is preferably formed so as to be matched to a frequency range of the emissions of sound through the air inlet opening. This makes it possible to achieve good damping of the sound emissions. The surface structure may have for example honeycombs, tubes, combinations thereof and/or the like.

The sound insulation wall may be designed for example as a thin wall, which is preferably formed to be substantially parallel to a plane in which the air inlet opening lies. Furthermore, it is of course possible that the sound insulation wall is formed or arranged obliquely with respect to said plane. The sound insulation wall need not constitute a plane with two Cartesian dimensions but may also be of curved form, for example may have one or more bends and/or the like. Dimensions of the sound insulation wall are preferably selected such that they extend beyond dimensions of the air inlet opening. The dimensions of the sound insulation wall may furthermore also be dependent on a distance of the sound insulation wall from the air inlet opening. In this regard, it may be provided that the dimensions are selected to be larger with increasing spacing of the sound insulation wall from the air inlet opening.

It is furthermore proposed that the sound insulation wall has, at least on the air inlet opening side, a sound insulation material. The sound insulation material may be formed integrally with the sound insulation wall. It may for example be arranged as a coating on that surface of the sound insulation wall which faces the air inlet opening. The sound insulation material may be fastened to the sound insulation wall for example by means of adhesive bonding, fastening means such as nails, rivets and/or the like, clamping and/or the like. The sound insulation material may comprise for example a fiber material which uses for example ceramic fibers, or else mineral wool, glass wool, steel wool, combinations thereof and/or the like. Furthermore, the sound insulation material may of course also comprise a plastic, in particular a foamed plastic, which may furthermore also be reinforced with fibers.

Finally, it is proposed that the fan wheel is designed in the manner of a radial fan and has a region formed in the manner of a diffuser, which region adjoins in the flow direction the at least one of the two air inlet openings, which is formed at least regionally in the manner of a nozzle. In this way, it is possible for better matching of a flow crossover from the air inlet opening to the fan wheel to be able to be realized. This allows not only the efficiency of the fan to be increased but also the noise generation to be further reduced.

Further advantages and features can be found in the following description of exemplary embodiments on the basis of the appended figures. In the figures, the same reference signs are used to denote identical features and functions.

In the figures:

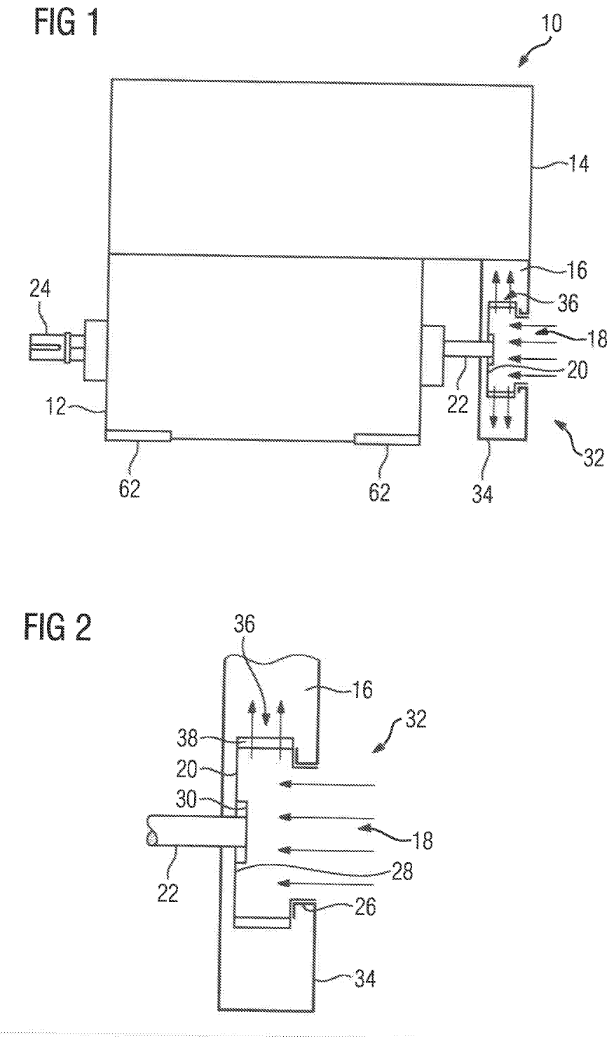

FIG. 1 shows a schematic side view of an electric machine with a heat exchanger, and with a single-channel fan in a sectional view,

FIG. 2 shows the sectional view of the single-channel fan in FIG. 1 in an enlarged illustration,

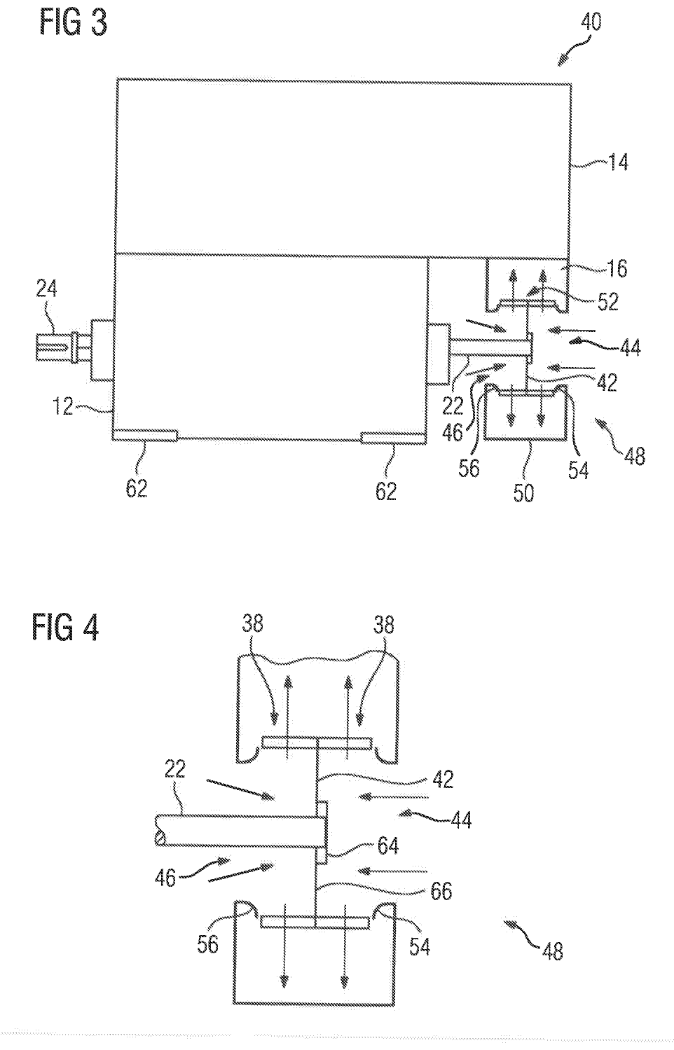

FIG. 3 shows a schematic illustration like FIG. 1, wherein the fan is designed here as a two-channel fan,

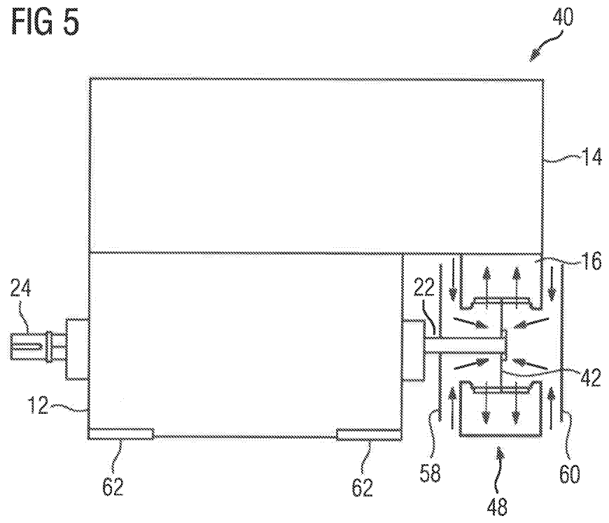

FIG. 4 shows a schematic illustration like FIG. 2, which shows an enlarged illustration of the two-channel fan as per FIG. 3, and

FIG. 5 shows a schematic illustration like FIG. 3, in which sound insulation walls are additionally provided.

FIG. 1 shows an electric machine 10 in a schematic side view, which has a housing 12 in which a stationary part of the electric machine 10 is arranged non-rotatably (not illustrated in the FIG). The stationary part provides a passage opening which forms a receiving space and in which a runner is rotatably mounted. The runner has a runner shaft, which has a drive end 24 and a non-drive end 22. The ends 22, 24 of the runner shaft project out of the housing 12 of the electric machine 10.

The electric machine 10 also comprises a cooling device for discharging heat from the housing 12 by means of a cooling fluid, this being air in the present case. The cooling device provides a closed cooling circuit and is connected to a heat exchanger 14. The cooling device itself is not illustrated in the FIG.

The heat exchanger 14 is able to be acted on by cooling air which is provided by a fan 32 via a cooling-air duct 16. The cooling air is released from the heat exchanger 14 to the surroundings via an air outlet opening (not illustrated further).

The fan 32 has a fan wheel 20 which is rotatably mounted in a fan housing 34 and which, in the present case, is designed as a radial fan wheel. The fan housing 34 comprises an air inlet opening 18 which is arranged at an end plate 26 and which, in the present case, is formed to be coaxial with an axis of rotation of the fan wheel 20. An air outlet opening 36 is formed in a radial direction of the fan wheel 20.

FIG. 2 shows an enlarged illustration of the fan 32 in a sectional illustration. It can be seen that the fan wheel 20 is flange-mounted on the end 22 of the runner shaft, whereby a fan hub 30 is formed and the axis of rotation is determined. The fan wheel 20 is therefore driven directly by the electric machine 10 itself. The fan 32 is consequently a single-channel fan.

The fan wheel 20 has air blades 38 which are arranged radially in the circumference and by means of which the air can be conveyed in an intended manner. The air blades 38 are mechanically connected to the end 22 of the runner shaft via a partition wall 28 of the fan hub 30.

The electric machine 10 is designed as a rotating electric machine. For setting up the electric machine 10, this has feet 62 which serve to make it possible for the electric machine 10 to be arranged on a suitable foundation. The electric machine 10 is fastened to the foundation by the feet 62.

FIG. 3 shows, in a schematic side view, an electric machine 40 with a sectioned fan in an illustration like FIG. 1, albeit now with a two-channel fan 48. The fan 48 has a fan housing 50 in which a fan wheel 42 is arranged so as to be drivable in rotation. The fan wheel 42 is—as with the preceding configuration—connected to a non-drive-side end 22 of a runner shaft of the electric machine 40.

The fan housing 50 has two opposing air inlet openings 44, 46, which are of substantially circular form in the present case. The fan wheel 42 is arranged between the air inlet openings 44, 46. In the present case, the fan wheel 42 is designed as a two-sided radial fan wheel, with the result that cooling air is correspondingly sucked in through both of the air inlet openings 44, 46 and conveyed into the cooling-air duct 16, which cooling-air duct has already been explained in relation to FIGS. 1 and 2. The further features of the electric machine 40 correspond to those features that have already been explained in relation to the electric machine 10 on the basis of FIGS. 1 and 2, and for this reason reference is additionally made to this embodiment. The configuration as per FIG. 3 consequently differs from the configuration as per FIG. 1 only by the fan 48, which, in comparison with the fan 32 in FIGS. 1 and 2, is of two-channel design in the present case.

In this exemplary embodiment too, an air outlet opening 52 is provided on the fan side, through which air outlet opening the cooling air provided by the fan 48 is conveyed into the cooling-air duct 16. The further function of the cooling corresponds to that already explained previously.

In the present case, the two air inlet openings 44, 46 are formed regionally in the manner of a nozzle 54, 56. In this way, improved air guidance is achieved, with the result that it is possible for noise generation to be reduced and the efficiency of the fan 48 to be improved.

FIG. 4 shows an enlarged illustration of the fan 48 as per FIG. 3. It can be seen that the fan wheel 42 is flange-mounted on the non-drive-side end 22 of the runner shaft by means of a fan hub 64. In this way, said fan wheel is connected rotationally conjointly to the runner shaft.

The fan wheel 42 has pairs of air blades 38, with the result that two separate air-conveying regions form, wherein in each case one of the air-conveying regions is associated with one of the two air inlet openings 44, 46. The air blades 38 are connected to the fan hub 64 via a centrally situated partition wall 66.

From FIG. 4, it can also clearly be seen that the air inlet openings 44, 46 each have a region 54, 56 which is formed in the manner of a nozzle. These regions 54, 56 are formed in an encircling manner with respect to the air inlet openings 44, 46.

FIG. 5 shows a further exemplary embodiment, wherein this configuration is based on the configuration as per FIGS. 3 and 4, and for this reason reference is additionally made to the related embodiments.

In comparison with the electric machine 40 in FIGS. 3 and 4, the electric machine 40 as per FIG. 5 additionally comprises in each case one sound insulation wall 58, 60 upstream of the two air inlet openings 44, 46 in the flow direction.

The sound insulation walls 58, 60 are designed as substantially planar metal walls in the present case and extend in their planar dimensions beyond the dimensions of the respective air inlet openings 44, 46. This makes it possible for further noise reduction to be achieved.

A spacing of the sound insulation walls 58, 60 with respect to the respective air inlet openings 44, 46 is in each case selected such that influence of the air flow, in particular of the flow resistance, is substantially negligible.

The sound insulation walls 48, 60 have, on the air inlet side, a sound insulation coating, which is formed by a plastic foam material in the present case. It is however alternatively or additionally also possible for use to be made of other fiber materials, for example mineral wool, glass wool, steel wool, combinations thereof and/or the like.

The exemplary embodiments serve merely for explaining the invention and are not intended to restrict the latter. It goes without saying that, with respect to the features, variations may be provided without departing from the basic concept of the invention. The region formed in the manner of a nozzle does not need to be formed in a completely circumferential manner with respect to the air inlet opening. It may be provided that also only a part of the air inlet opening is formed in the manner of a nozzle. Furthermore, it goes without saying that provision may be made for further adaptations in terms of flow in the region of the air inlet openings in the context of the invention.

What is claimed is:

1.-4. (canceled)

5. An electric machine, comprising:
a housing;
a stationary part non-rotatably mounted in the housing;
a runner rotatably mounted in a receiving space of the stationary part;
a cooling device configured to discharge heat from the housing by providing a closed cooling circuit for a cooling fluid on a machine side;
a heat exchanger arranged on the housing and coupled to the cooling device, said heat exchanger being configured to allow cooling air to act on the heat exchanger and to allow passage of the cooling fluid, with the cooling fluid and the cooling air being separated in the heat exchanger by guiding the cooling air through cooling tubes of the heat exchanger and the cooling device being fluidically coupled to the heat exchanger;
a cooling-air duct for supply and/or discharge of the cooling air; and
a fan configured as a two-channel shaft fan for introducing the cooling air into the cooling-air duct, said fan including a fan housing having two opposing air inlet openings configured as nozzles, respectively, a two-sided radial fan wheel rotatably mounted in the fan housing and arranged between the air inlet openings so as to allow intake of cooling air through the two air inlet openings and conveyance thereof into the cooling-air duct, and a single air outlet opening which is arranged in a radial direction of the fan wheel and through which the cooling air provided by the fan is conveyed into the cooling-air duct.

6. The electric machine of claim 5, further comprising a diffuser adjoining a region of the nozzles in a flow direction.

7. The electric machine of claim 5, further comprising a sound insulation wall formed upstream of at least one of the two air inlet openings in a flow direction.

8. The electric machine of claim 7, wherein the sound insulation wall has a sound insulation material on a side of the air inlet openings.
